(19) United States
(12) Patent Application Publication
(10) Pub. No.: US 2016/0025270 A1
(43) Pub. Date: Jan. 28, 2016

(54) FUEL SUPPLY SYSTEM

(71) Applicant: AISAN KOGYO KABUSHIKI KAISHA, Obu-shi (JP)

(72) Inventors: Taku MASAKI, Novi, MI (US); Takashi KANIE, Toyoake-shi (JP)

(73) Assignee: AISAN KOGYO KABUSHIKI KAISHA, Obu-shi (JP)

(21) Appl. No.: 14/804,832

(22) Filed: Jul. 21, 2015

(30) Foreign Application Priority Data
Jul. 25, 2014 (JP) 2014-151610

(51) Int. Cl. F17D 1/14

(52) U.S. Cl. CPC F17D 1/14

(57) ABSTRACT

A fuel supply system has a fuel tank, a sub-tank, a fuel pump, an attachment member, and one or more shaft members. The fuel tank has an upper wall and a lower wall. The sub-tank is located on the lower wall inside the fuel tank and has one or more guide portions. The fuel pump is housed in the sub-tank. The attachment member is attached to the upper wall of the fuel tank and has a plurality of support portions. The shaft members are attached to the support portions so as to extend downward from the support portions and are slidably inserted into the guide portions of the sub-tank, respectively, such that the attachment member is connected with the sub-tank and is movable relative to the sub-tank in the vertical direction. The number of the support portions is greater than the number of the shaft members. The shaft members are selectively attached to the support portions.

### CROSS-REFERENCE TO RELATED APPLICATIONS

This application claims priority to Japanese patent application serial number 2014-151610, filed Jul. 25, 2014, the contents of which are incorporated herein by reference.

### STATEMENT REGARDING FEDERALLY SPONSORED RESEARCH OR DEVELOPMENT

Not applicable.

### BACKGROUND

This disclosure relates to an in-tank type fuel supply system housed in a fuel tank.

A conventional fuel supply system disclosed in Japanese Laid-Open Patent Publication No. 2004-76702 has a sub-tank, a fuel pump, an attachment member, and two shaft members. The sub-tank is provided in the fuel tank such that the sub-tank is mounted on a bottom wall of the fuel tank. The fuel is supplied from the fuel tank into the sub-tank. The fuel pump delivers the fuel from the sub-tank to the outside of the fuel tank. The attachment member is attached to an upper wall of the fuel tank. The shaft members connect the attachment member with the sub-tank such that the attachment member and the sub-tank can move in the vertical direction. The attachment member has a pair of support portions for hanging the pair of the shaft members, respectively. The sub-tank has a pair of guide portions. The pair of the shaft members are inserted into the guide portions, respectively, such that the shaft members can slide in the axial direction.

With respect to the fuel supply system having a sub-tank (including a sender gauge, etc.) and an attachment member (including a fuel outlet pipe, etc.), in some case, a manufacturer would like to alter a positional relationship between the sub-tank and the attachment member. However, in the conventional fuel supply system, it is not assumed that the positional relationship between the sub-tank and the attachment member will be changed. Thus, when changing the positional relationship, it is necessary to newly make the sub-tank or the attachment member. Accordingly, there has been a need for improved fuel supply systems.

### BRIEF SUMMARY

In one aspect of this disclosure, a fuel supply system has a fuel tank, a sub-tank, a fuel pump, an attachment member, and one or more shaft members. The fuel tank has an upper wall and a lower wall. The sub-tank is located on the lower wall inside the fuel tank and has one or more guide portions. The fuel pump is housed in the sub-tank. The attachment member is attached to the upper wall of the fuel tank and has a plurality of support portions. The shaft members are attached to the support portions so as to extend downward from the support portions and are slidably inserted into the guide portions of the sub-tank, respectively, such that the attachment member is connected with the sub-tank and is movable relative to the sub-tank in the vertical direction. The number of the support portions is greater than the number of the shaft members. The shaft members are selectively attached to the support portions.

According to the aspect of this disclosure, the relative position of the attachment member in relation to the sub-tank can be changed by selectively attaching the shaft members to the support portions. Thus, the relative position of the attachment member in relation to the sub-tank can be easily changed without newly making another attachment member.

### BRIEF DESCRIPTION OF THE DRAWINGS

FIG. 1 is a perspective view of a fuel supply system according to a first embodiment.

FIG. 2 is a front view of the fuel supply system.

FIG. 3 is a plan view of the fuel supply system.

FIG. 4 is a cross-sectional view along a line IV-IV shown in FIG. 2.

FIG. 5 is a cross-sectional view along a line V-V shown in FIG. 2.

FIG. 6 is a cross-sectional view showing a connection structure between a set plate and a sub-tank.

FIG. 7 is a perspective view of the fuel supply system where the position of the set plate is changed.

FIG. 8 is a plan view of the fuel supply system where the position of the set plate is changed.

FIG. 9 is a bottom view of the set plate.

FIG. 10 is a bottom view of the set plate according to a second embodiment.

FIG. 11 is a bottom view of the set plate according to a third embodiment.

FIG. 12 is a bottom view of the set plate according to a fourth embodiment.

FIG. 13 is a bottom view of the set plate according to a fifth embodiment.

### DETAILED DESCRIPTION

Each of the additional features and teachings disclosed above and below may be utilized separately or in conjunction with other features and teachings to provide improved fuel supply systems. Representative examples, which utilize many of these additional features and teachings both separately and in conjunction with one another, will now be described in detail with reference to the attached drawings. This detailed description is merely intended to teach a person of skilled in the art further details for practicing preferred aspects of the present teachings and is not intended to limit the scope of the invention. Only the claims define the scope of the claimed invention. Therefore, combinations of features and steps disclosed in the following detailed description may not be necessary in the broadest sense, and are instead taught merely to particularly describe representative examples. Moreover, various features of the representative examples and the dependent claims may be combined in ways that are not specifically enumerated in order to provide additional useful embodiments of the present teachings.

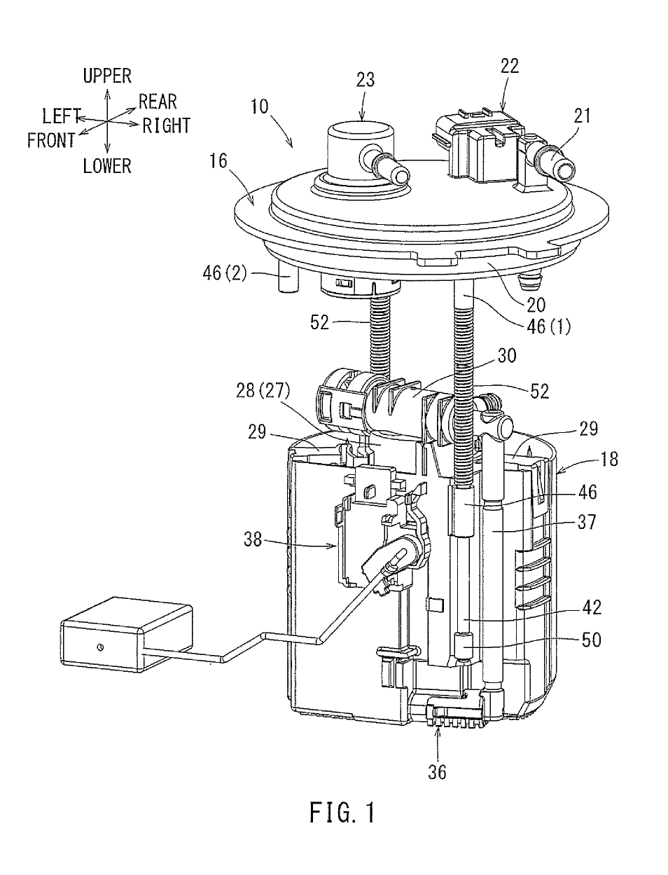

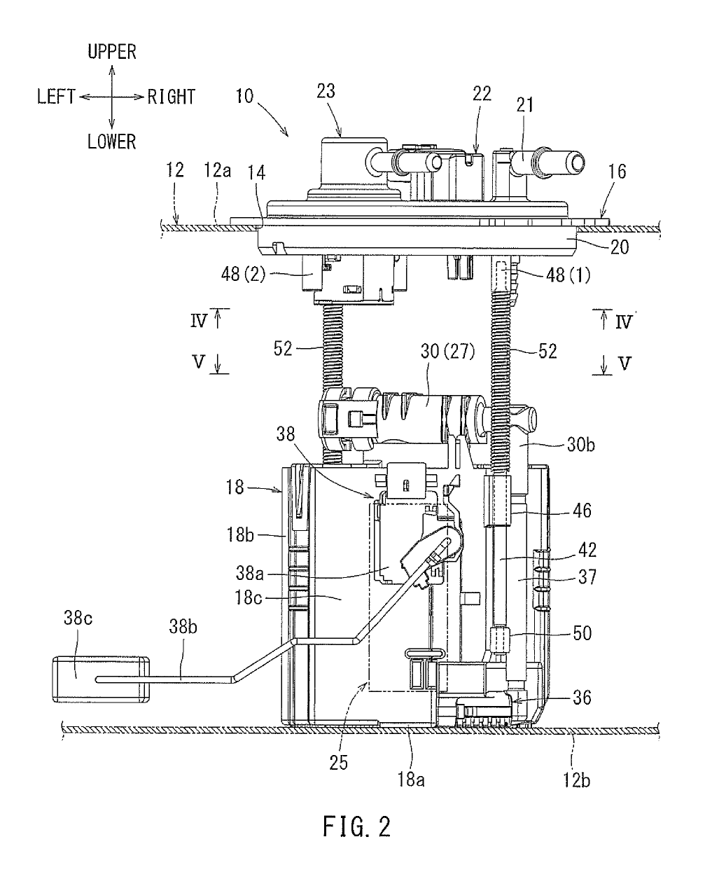

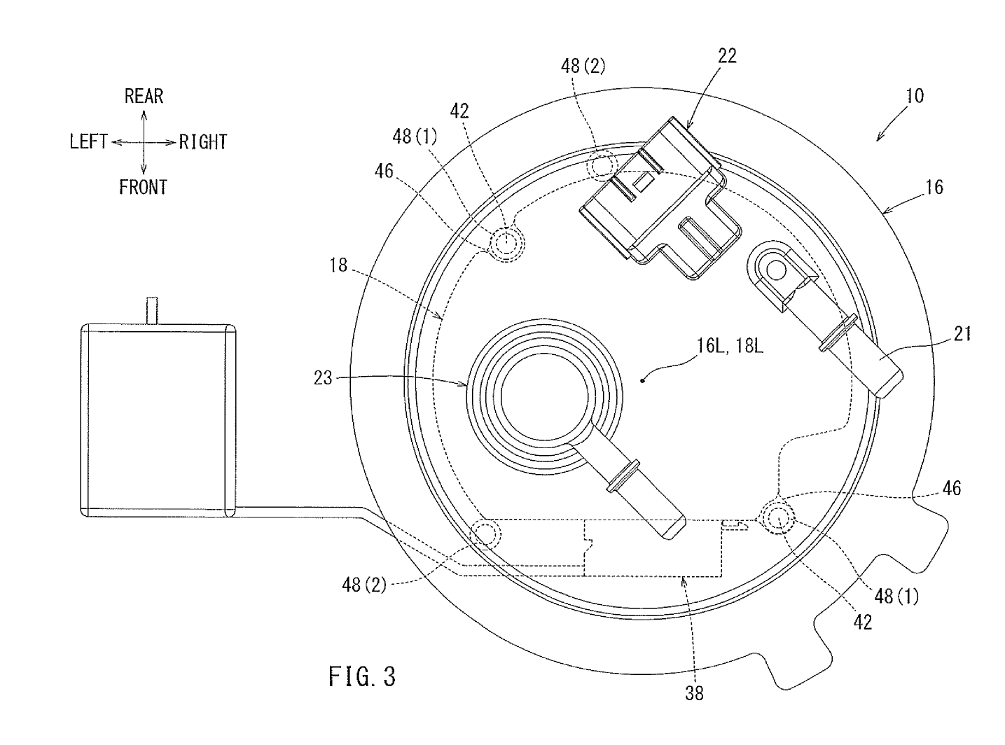

A fuel supply system 10 according to a first embodiment will be described. FIGS. 1-3 show the fuel supply system 10 according to the first embodiment of this disclosure. Front, rear, left, and right directions of the fuel supply system 10 are defined based on the plan view of FIG. 3, however such directions do not limit the installation directions of the fuel supply system 10. In the following description, for convenience of explanation, sometimes one of the plural same members will be described as an example. In such case, when there is no exceptional description, other members have the same structure and/or characteristics. As shown in FIG. 2, the fuel supply system 10 is installed in a fuel tank 12 for a vehicle such as automobile. The fuel supply system 10 is configured to supply fuel from the inside of the fuel tank 12 to the outside of the fuel tank 12, that is, to an internal combustion engine (not shown) via a sub-tank 18. The fuel is liquid fuel such as gasoline. The fuel tank 12 is a hollow container made from, for example, a resin material and has an upper wall 12a and a bottom wall 12b. The upper wall 12a and the bottom wall 12b are positioned to be parallel to each other. The upper wall 12a has an opening 14 formed in a circular shape.

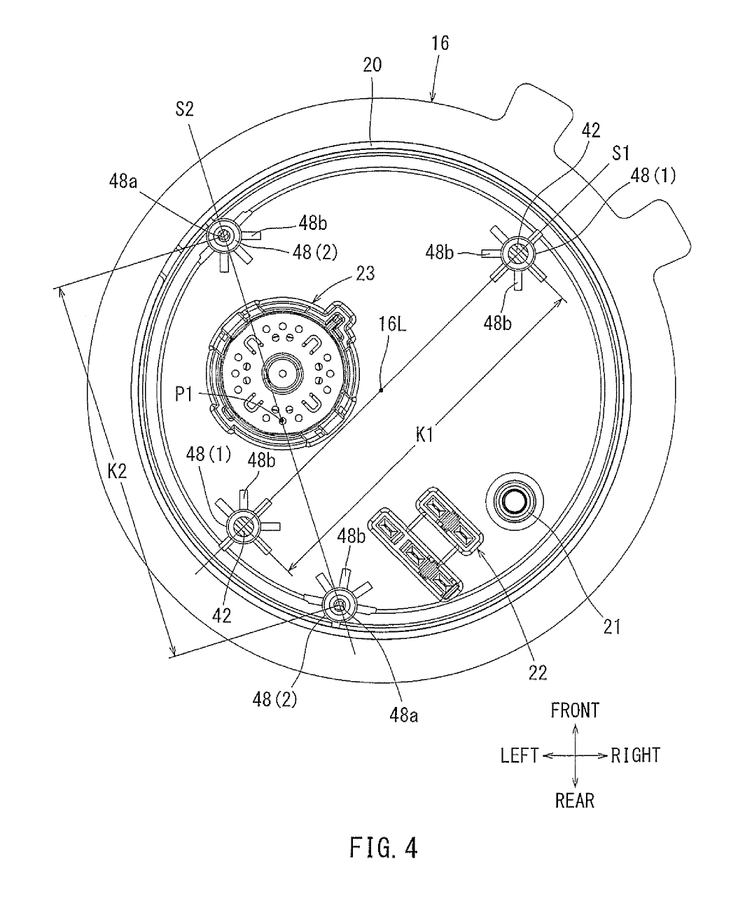

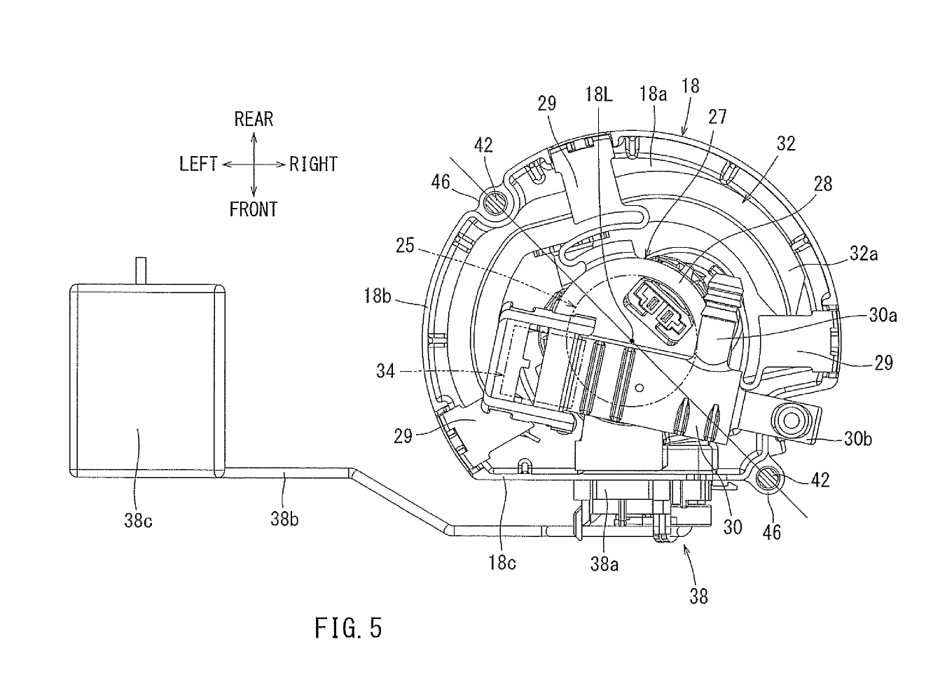

The fuel supply system 10 has a set plate 16 and the sub-tank 18. FIG. 4 is a cross-sectional view along a line IV-IV shown in FIG. 2. FIG. 5 is a cross-sectional view along a line V-V shown in FIG. 2. As shown in FIG. 4, the set plate 16 is made from a resin material and is formed in a circular plate shape. At a lower surface of the set plate 16, a fitting cylinder portion 20 is concentrically provided and is formed in a short hollow cylindrical shape. The fitting cylinder portion 20 has a smaller outer diameter than that of the set plate 16. The set plate 16 is attached to the upper wall 12a of the fuel tank 12 such that the fitting cylinder portion 20 is fitted into the opening 14 for closing the opening 14 (see FIG. 2).

The set plate 16 has a fuel outlet pipe 21, an electrical connector 22 and a fuel cutoff valve 23. At the lower surface of the set plate 16, the fuel outlet pipe 21, the electrical connector 22 and the fuel cutoff valve 23 are positioned inside the fitting cylinder portion 20. At an upper surface of the set plate 16 (see FIG. 3), the fuel outlet pipe 21 is connected with a fuel supply pipe for supplying the fuel to the outside, that is, to the internal combustion engine (not shown). The electrical connector 22 is attached with an external connector (not shown) connected to an external power source and a control unit (ECU). The fuel cutoff valve 23 is connected with a vaporized fuel inlet pipe (not shown) for introducing vaporized fuel from the inside of the fuel tank to a canister. The fuel cutoff valve 23 is normally open. When the vehicle, for example, inclines or overturns, the fuel cutoff valve 23 is closed. The set plate 16 corresponds to an attachment member in this disclosure.

As shown in FIG. 2, the sub-tank 18 is mounted on a bottom portion in the fuel tank 12, that is, on the bottom wall 12b. The sub-tank 18 is made from a resin material and is formed in a hollow cylindrical shape having an upper opening and a closed bottom. The sub-tank 18 has a bottom wall 18a and a circumferential wall 18b. The circumferential wall 18b includes a front wall 18c. The front wall 18c is formed in a flat plate shape and faces in the front direction. As shown in FIG. 5, a fuel pump 25 is vertically housed in the sub-tank 18 via a retention member 27. The fuel pump 25 is a Wesco-type electric fuel pump. The fuel pump 25 is formed in a cylindrical shape. The fuel pump 25 has a fuel inlet (not shown) on the lower surface side for sucking the fuel, and has a fuel outlet (not shown) on the upper surface side for discharging the fuel.

The retention member 27 is made from a resin material and integrally has a casing 28, elastic support pieces 29 and a fuel piping portion 30. The casing 28 houses the fuel pump 25 therein. The fuel pump 25 is electrically connected with the electrical connector 22 of the set plate 16 (see FIG. 4) via a cable harness (not shown). The fuel pump 25 is driven by the external power source. The fuel inlet of the fuel pump 25 is connected with a suction filter 32. The suction filter 32 has a bag-shaped filter member 32a for filtering the fuel. The filter member 32a is made of, for example, nonwoven fabric, mesh material, filter paper, or knitted cloth. The filter member 32a is housed in the sub-tank 18 and is formed in a hollow cylindrical shape having a C shaped cross-section. The filter member 32 extends vertically to surround the casing 28.

A plurality of (for example, three) elastic support pieces 29 are radially provided at an upper end of the casing 28. An outer end of each elastic support piece 29 is engaged with an upper end of the circumferential wall 18b of the sub-tank 18. The elastic support pieces 29 elastically support the casing 28. The fuel piping portion 30 is provided on the upper end of the casing 28.

The fuel piping portion 30 is connected to the fuel outlet (not shown) of the fuel pump 25. The fuel piping portion 30 includes a feed fuel outlet 30a and a surplus fuel outlet 30b. The feed fuel outlet 30a is connected to the fuel outlet pipe 21 of the set plate 16 (see FIG. 4) via a flexible pipe (not shown). The fuel piping portion 30 incorporates a pressure regulator 34 (see FIG. 5). The pressure regulator 34 adjusts a pressure of the fuel discharged from the fuel pump 25 to a predetermined pressure and sends the resulting surplus fuel to the surplus fuel outlet 30b. As shown in FIG. 2, a jet pump 36 is provided at a bottom portion of the sub-tank 18. The jet pump 36 is connected to the surplus fuel outlet 30b via a circulation pipe 37 having flexibility.

As shown in FIG. 5, a sender gauge 38 is attached to a front surface of the front wall 18c of the circumferential wall 18c of the sub-tank 18. The sender gauge 38 has a sensor body 38a attached to the front wall 18c, an arm 38b rotatably attached to the sensor body 38a, and a float 38c provided at a free end of the arm 38b (see FIG. 2). The sensor body 38a is electrically connected to the electrical connector 22 of the set plate 16 (see FIG. 4) via a cable harness (not shown). The float 38c moves in the vertical direction depending on changes of the remaining amount of the fuel, that is, the liquid level in the fuel tank 12. The sensor body 38a detects changes of the rotation of the arm 38b caused by the movement of the float 38c, and then converts the changes to signals and outputs the signals to the control unit (ECU). Thus, the remaining amount of the fuel in the fuel tank 12 can be detected.

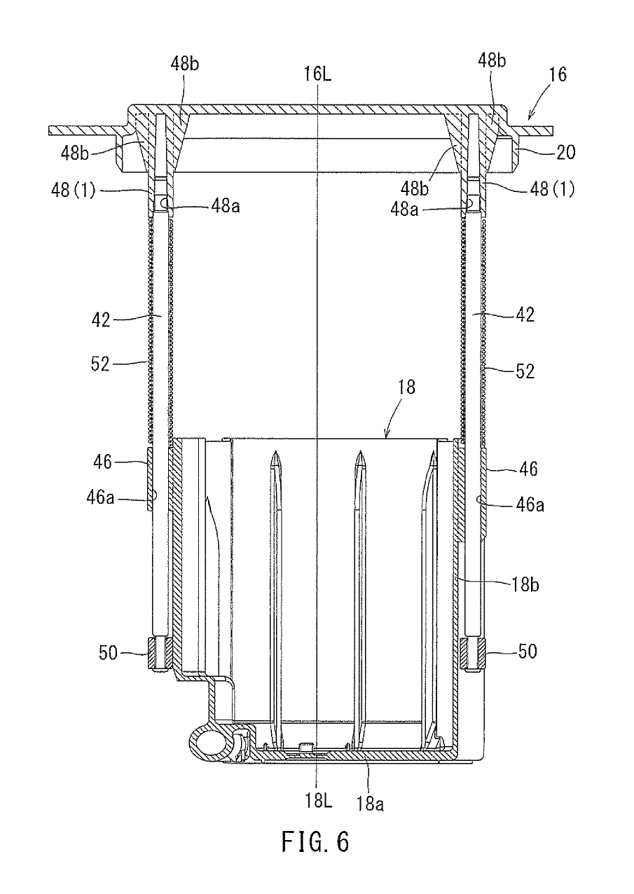

As shown in FIG. 2, a pair of right and left shaft members 42 (one of them is shown in FIG. 2) are provided between the set plate 16 and the sub-tank 18 such that the set plate 16 and the sub-tank 18 can move vertically, that is, such that the distance between the set plate 16 and the sub-tank 18 is extendable in the vertical direction. FIG. 6 shows a cross-sectional view showing a connection structure between the set plate 16 and the sub-tank 18. In FIG. 6, components relating to the connection structure are shown, on the other hand, other components are not shown. Each of the shaft members 42 is made from, for example, metal and is formed in a solid shaft shape having a circular cross-section.

A pair of right and left guide portions 46 are integrally formed at an outer circumferential portion of an upper end of the circumferential wall 18b of the sub-tank 18. Each of the guide portions 46 is formed in a hollow cylindrical shape having an insertion hole 46a. As shown in FIG. 5, the right guide portion 46 is positioned at a right end portion of the front wall 18c of the circumferential wall 18b. The left guide portion 46 is located at a position in point symmetry with the right guide portion 46 about an axis 18L of the sub-tank 18. That is, the right and left guide portions 46 are in point symmetry with respect to the axis 18L.

As shown in FIG. 4, a plurality of (four, in this case) support portions 48 are integrally formed at a lower surface of the set plate 16. Here, the number of the support portions 48 is set to be greater than the number of the shaft members 42. As shown in FIG. 6, each of the support portions 48 is formed in a hollow cylindrical shape having an open lower end and a closed upper end. In each support portion 48, an engagement hole 48a is formed to be a taper shape narrowing upwardly. A plurality of reinforcing ribs 48b are integrally and radially formed at an outer circumference of each support portion 48.

As shown in FIG. 4, the four support portions 48 are divided into two groups. Two of the support portions 48, which are located on a line S1 extending through an axis 16L of the set plate 16, are divided into a group A support portions 48(1). The other two support portions 48 are divided into a group B support portions 48(2). The group A support portions 48(1) are located on the line Si and are in point symmetry with respect to the axis 16L. In a plan view, in a state that the axis 16L of the set plate 16 is identical to the axis 18L of the sub-tank 18, the group A support portions 48(1) are located to be identical to the guide portions 46 of the sub-tank 18, respectively (see FIG. 3).

As shown in FIG. 4, an eccentric point P1 is set to be a point where the axis 16L of the set plate 16 is moved radially, that is, in a substantial leftward direction. The group B support portions 48(2) are located on a line S2 extending through the eccentric point P1 and are in point symmetry with the eccentric point P1. The distance K2 between the group B support portions 48(2) are same with the distance K1 between the group A support portions 48(1).

As shown in FIG. 6, the engagement holes 48a of the group A support portions 48(1) are engaged with upper ends of the shaft members 42, respectively, by press fitting. Thus, the set plate 16 supports the shaft members 42 such that the shaft members 42 hang from the set plate 16. A lower part of each shaft member 42 is inserted into the insertion hole 46a of the corresponding guide portion 46 and can slide in the axial direction of the shaft member 42. A lower end of each shaft member 42 is equipped with a retaining member 50, which is made from a resin material and is formed in a substantial cylindrical shape having a C-shaped cross-section. Each retaining member 50 is attached to the corresponding shaft member 42 by using elastic deformation of the retaining member 50 such that the retaining member 50 cannot move relatively with respect to the shaft member 42 in the axial direction. Each retaining member 50 is configured to prevent the shaft member 42 from falling out by contacting the corresponding guide portions 46.

Each of the shaft members 42 is fitted into a coil spring 52 made from, for example, metal. Each coil spring 52 is located between the corresponding group A support portion 48(1) and the corresponding guide portion 46. Each coil spring 52 biases the set plate 16 and the sub-tank 18 in a direction away from each other along the axial direction of the corresponding shaft 42. That is, the sub-tank 18 is biased downwardly and is pressed against the bottom wall 12b of the fuel tank 12 due to biasing force of the coil springs 52 (see FIG. 2). Here, each of the coil springs 52 corresponds to “biasing means”. In FIGS. 4 and 5, the coil springs 52 are omitted.

In a state that the fuel supply system 10 is located in the fuel tank 12 (see FIG. 2), when the fuel tank 12 expands or contracts due to changes of the inner pressure caused by temperature alteration and/or changes of the fuel amount, the sub-tank 18 moves in the vertical direction along the shaft members 42. And, after the sub-tank 18 vertically moves, the sub-tank 18 is always pressed against the bottom wall 12b of the fuel tank 12 due to biasing force of the coil springs 52.

With respect to the fuel supply system 10, when the fuel pump 25 is driven, the fuel in the sub-tank 18 is filtered by the suction filter 32 and then is sucked by the fuel pump 25. After the fuel pump 25 sucks the fuel, the fuel pump 25 pressurizes the fuel therein, and then discharges the fuel into the fuel piping portion 30 of the casing 28. The fuel discharged into the fuel piping portion 30 flows through the flexible pipe (not shown), the fuel outlet pipe 21 of the set plate 16 and the fuel supply pipe (not shown) and is supplied to the internal combustion engine (not shown). Further, the pressure regulator 34 adjusts the pressure of the fuel supplied from the fuel piping portion 30 to the internal combustion engine (not shown), and surplus fuel resulting from such adjustment is supplied to the jet pump 36 via the circulation pipe 37. The jet pump 36 utilizes flow of the surplus fuel in order to transfer the fuel from the fuel tank 12 to the sub-tank 18.

The relative position of the set plate 16 in relation to the sub-tank 18 is shown in FIGS. 1-3. However, considering positional relationship between the components (for example, the sender gauge 38) of the sub-tank 18 and the components (for example, the fuel outlet pipe 21) of the set plate 16, in some cases, a manufacturer would like to alter the positional relationship between the sub-tank 18 and the set plate 16.

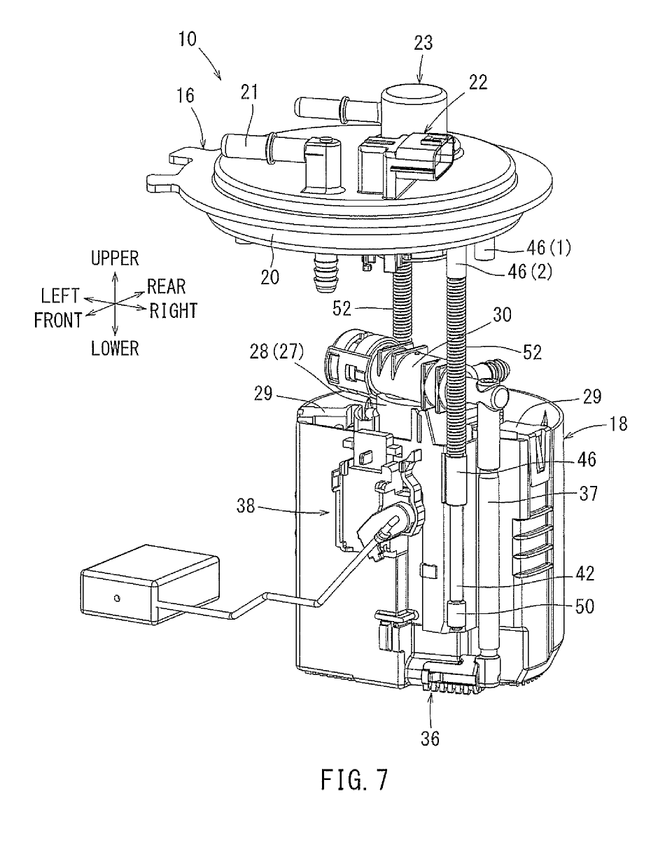

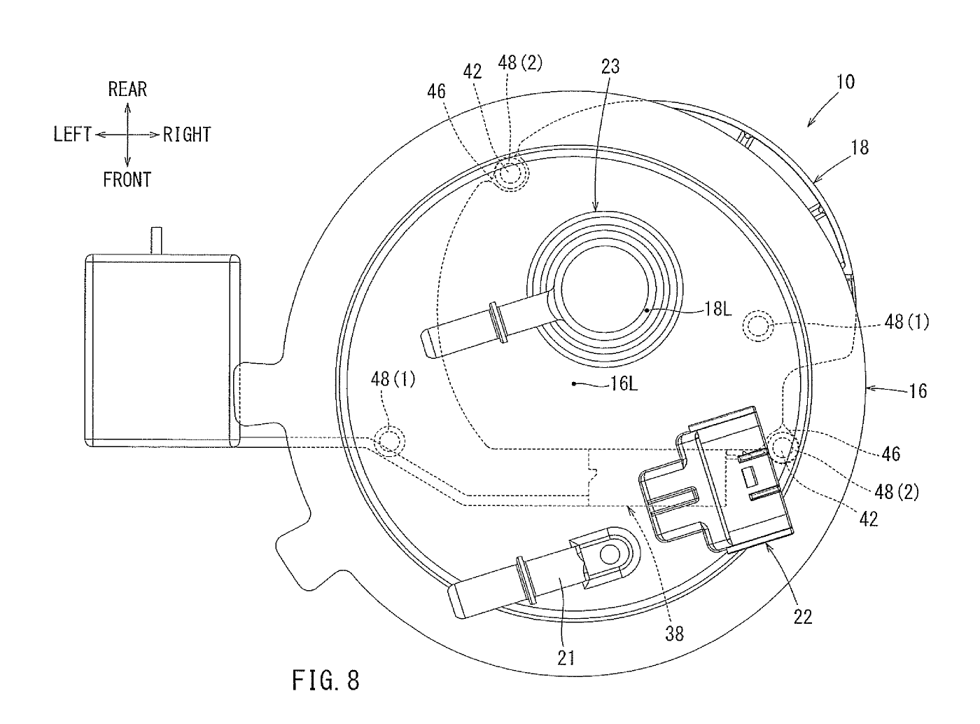

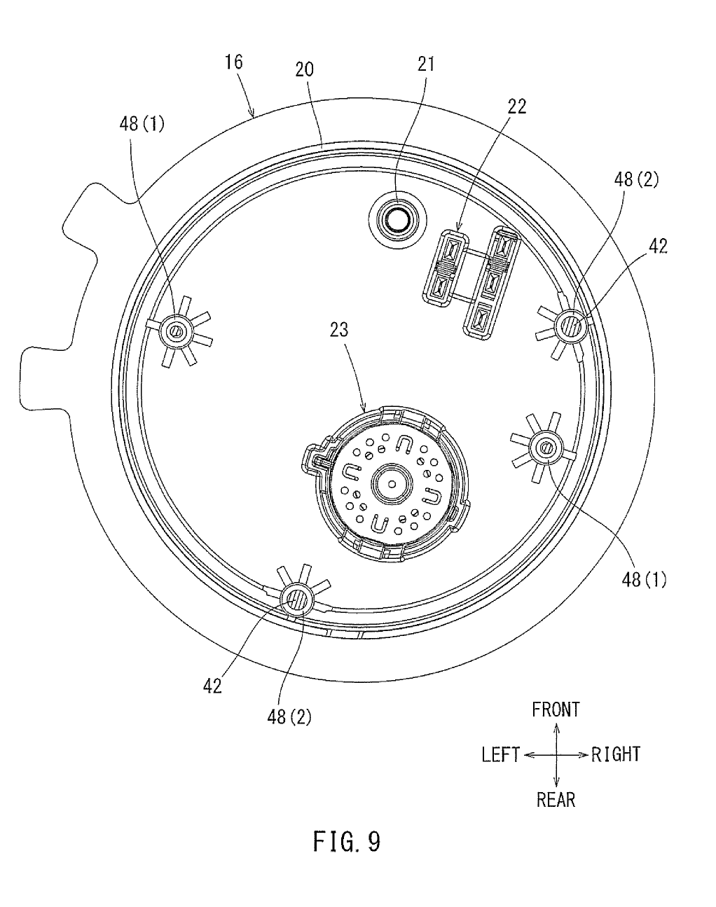

FIGS. 7-9 show the fuel supply system 10 where the position of the set plate 16 has been changed. In such case, as shown in FIG. 9, the shaft members 42 can be supported by the group B support portions 48(2), respectively, instead of the group A support portions 48(1). Other configurations are not changed. Due to this, as shown in FIG. 8, the positional relationship can be altered such that the axis 18L of the sub-tank 18 can be eccentric relative to the axis 16L of the set plate 16 and that the set plate 16 and the sub-tank 18 are deviated in the circumferential direction (see FIG. 7). Accordingly, the positional relationship between the set plate 16 and the sub-tank 18 in the horizontal direction can be easily changed without newly making another set plate 16.

In accordance with the fuel supply system 10, the relative position of the set plate 16 in relation to the sub-tank 18 can be changed by selectively attaching the shaft members 42 to either the group A support portions 48(1) or the group B support portions 48(2). Therefore, the relative position of the set plate 16 in relation to the sub-tank 18 can be easily changed without newly making another set plate 16.

Here, the number of the shaft members 42 is two. Accordingly, two shaft members 42 can improve connection state between the set plate 16 and the sub-tank 18.

It is configured to be able to change the relative position of the set plate 16 in relation to the sub-tank 18 both in the circumferential direction of the axis 18L and in the radial direction of the axis 18L. Therefore, the relative position of the set plate 16 in relation to the sub-tank 18 can be changed in the circumferential direction of the axis 18L and can be changed in the radial direction of the axis 18L.

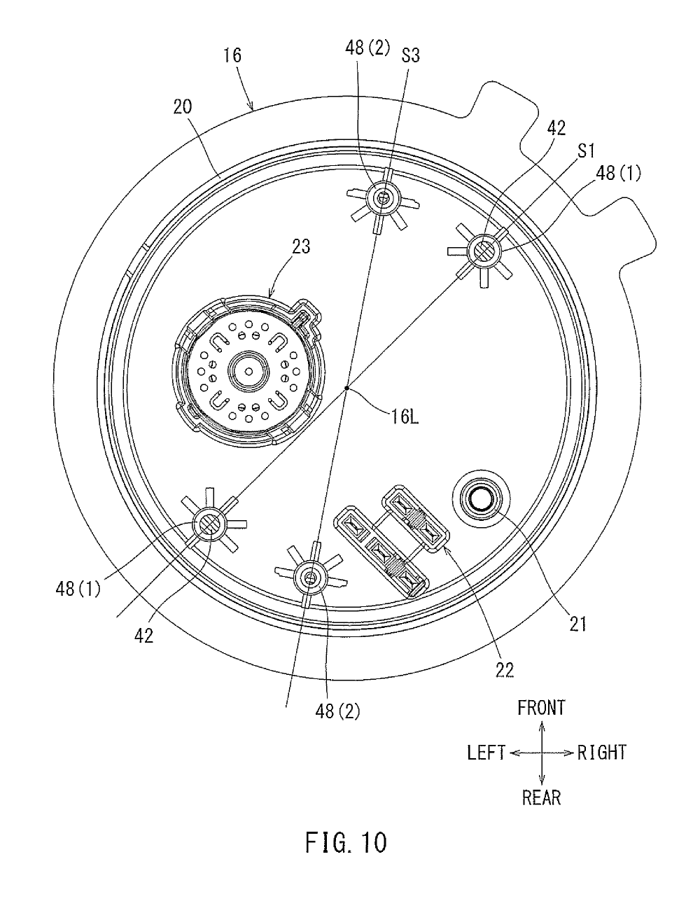

The fuel supply system 10 according to a second embodiment will be described. Because each of following embodiments is identical to the first embodiment with some modifications, the modifications will be described and the same configurations will not be described. FIG. 10 shows the lower surface of the set plate 16 according to the second embodiment. As shown in FIG. 10, the positions of the group B support portions 48(2) at the set plate 16 are changed compared with those in the first embodiment. The group B support portions 48(2) are located on a line S3, which extends through the axis 16L of the set plate 16 and intersects with the line S1, and are in point symmetry with respect to the axis 16L. In this case, the relative position of the set plate 16 in relation to the sub-tank 18 can be changed in the circumferential direction while remaining the set plate 16 and the sub-tank 18 on the same axis. Such alteration of the relative position of the set plate 16 in relation to the sub-tank 18 can be performed by selecting either the group A support portions 48(1) or the group B support portions 48(2). Here, the intersection angle between the line 51 and the line S3 can be altered as appropriate. In accordance with this embodiment, the relative position of the set plate 16 in relation to the sub-tank 18 can be changed in the circumferential direction of the axis 18L.

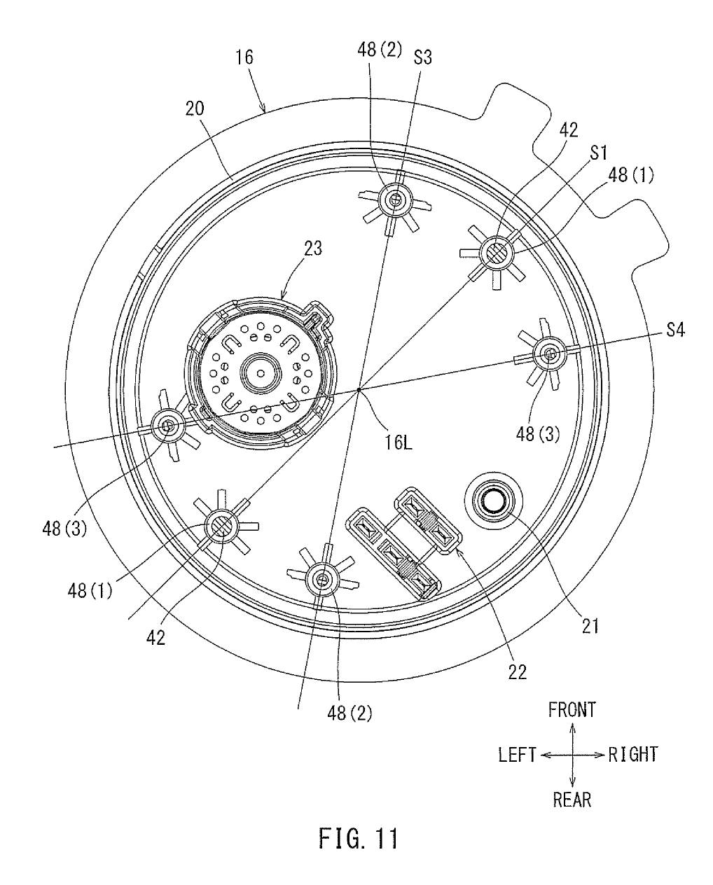

The fuel supply system 10 according to a third embodiment will be described. FIG. 11 shows the lower surface of the set plate 16 according to the third embodiment. As shown in FIG. 11, a pair of group C support portions 48(3) are further provided at the set plate 16. The group C support portions 48(3) are located on a line S4, which extends through the axis 16L of the set plate 16 and intersects with both the line 51 and the line S3, and are in point symmetry with respect to the axis 16L. The distance between the group C support portions 48(3) is same with both the distance between the group A support portions 48(1) and the distance between the group B support portions 48(2). In this case, the relative position of the set plate 16 in relation to the sub-tank 18 can be changed by selecting either the group A support portions 48(1), the group B support portions 48(2) or the group C support portions 48(3).

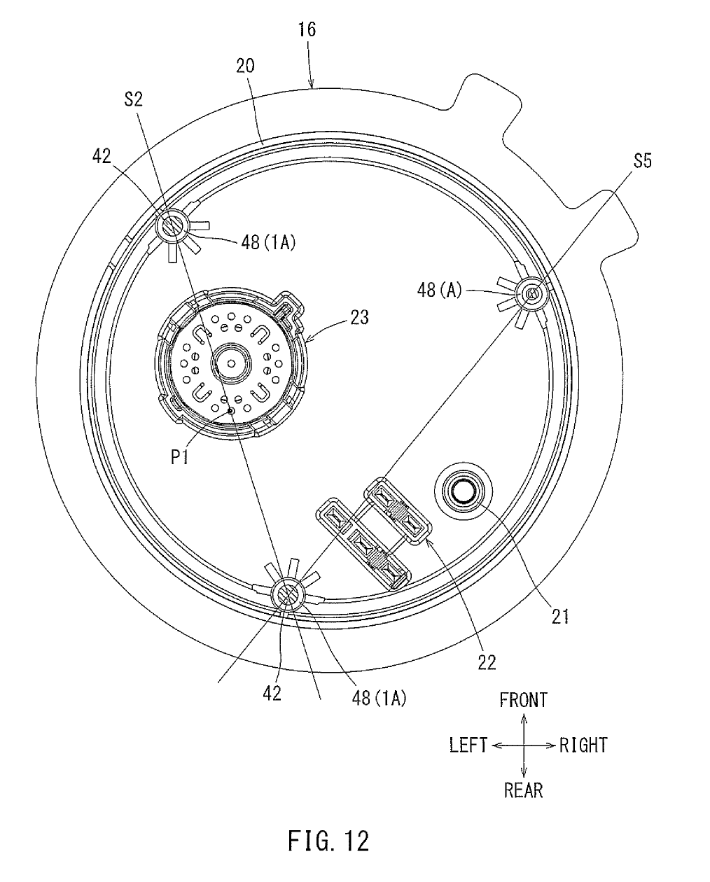

The fuel supply system 10 according to a fourth embodiment will be described. FIG. 12 shows the lower surface of the set plate 16 of the fourth embodiment. As shown in FIG. 12, the set plate 16 does not have the group A support portions 48(1) of the first embodiment. And, the group B support portions 48(2) are renamed as group A support portions 48(1A). An additional support portion 48(A) is provided on a line S5 extending through an axis of the right one of the group A support portions 48(1A) and intersecting with the line S2. The distance between the support portion 48(1A) and the support portion 48(A) along the line S5 is same with the distance between the support portions 48(1A). In this case, the relative position of the set plate 16 in relation to the sub-tank 18 can be changed by selecting either the pair of the group A support portions 48(1A) or a combination of the additional support portion 48(A) with the right group A support portion 48(1A). Here, the angle and the position of the intersection between the line S2 and the line S5 can be changed as appropriate.

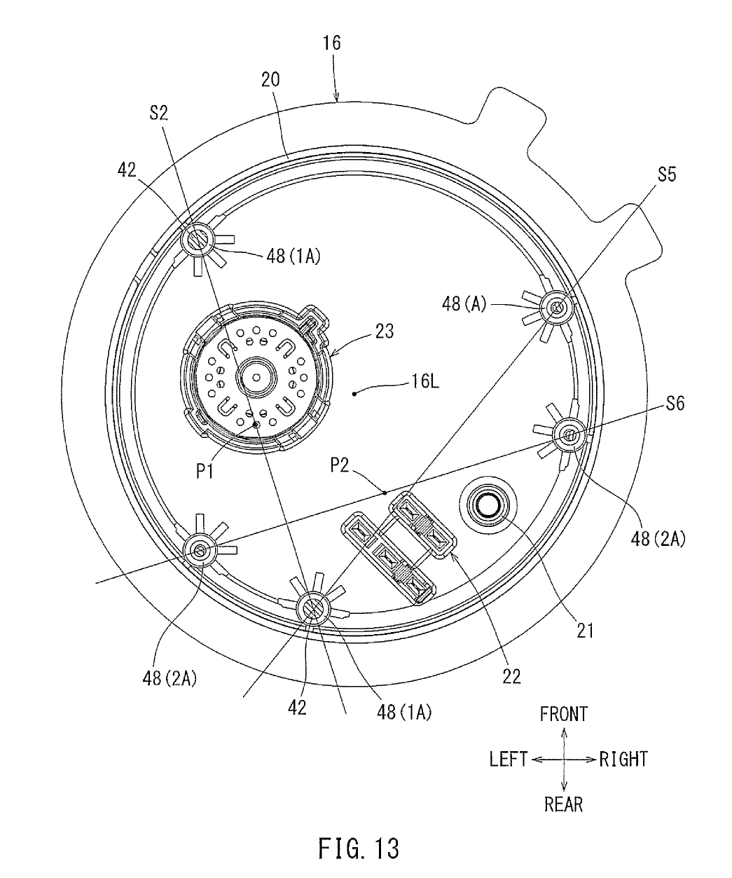

The fuel supply system 10 according to a fifth embodiment will be described. FIG. 13 shows the lower surface of the set plate 16 of the fifth embodiment. As shown in FIG. 13, a pair of group B support portions 48(2A) are additionally provided at the set plate 16 of the fourth embodiment. The group B support portions 48(2A) are located on a line S6 extending through an eccentric point P2 and are in point symmetry with respect to the eccentric point P2. The eccentric point P2 is shifted in a radial direction (that is, rearward) from the axis 16L of the set plate 16. The line S6 intersects with both the line S2 and the line S5. The distance between the group B support portions 48(2A) is same with the distance between the group A support portions 48(1A). In this case, the relative position of the set plate 16 in relation to the sub-tank 18 can be changed by selecting either the pair of the group A support portions 48(1A), the pair of the group B support portions 48(2A), or the combination of the additional support portion 48(A) with the right group A support portion 48(1A). The angles and the positions of the intersections between two of the line S2, the line S5 and the line S6 can be changed as appropriate.

This disclosure is not limited to the above-described embodiments and can be modified without departing from the scope of the invention. For example, the fuel tank 12 can be made from metal. The relative position of the set plate 16 in relation to the sub-tank 18 can be changed only in the radial direction of the axis 18L. The number of the shaft members 42 can be set to be one, three or more. Each of the shaft members 42 can have a cross-sectional shape other than the circular shape, for example, polygonal shape. The shaft members 42 can be made from resin materials. The coil springs 52 can be omitted.

1. A fuel supply system, comprising:
a fuel tank having an upper wall and a lower wall;
a sub-tank located on the lower wall inside the fuel tank and having one or more guide portions;
a fuel pump housed in the sub-tank;
an attachment member attached to the upper wall of the fuel tank and having a plurality of support portions; and
one or more shaft members attached to the support portions so as to extend downward from the support portions and slidably inserted into the guide portions of the sub-tank, respectively, such that the attachment member is connected with the sub-tank and such that the attachment member and the sub-tank are movable relative to each other in the vertical direction;
wherein the number of the support portions is greater than the number of the shaft members; and
wherein the shaft members are selectively attached to the support portions.

2. The fuel supply system according to claim 1,
wherein the number of the shaft members is two.

3. The fuel supply system according to claim 1,
wherein the support portions are positioned such that the relative position of the attachment member in relation to the sub-tank can be changed in the circumferential direction with respect to an axis of the sub-tank.

4. The fuel supply system according to claim 1,
wherein the support portions are positioned such that the relative position of the attachment member in relation to the sub-tank can be changed in the radial direction with respect to an axis of the sub-tank.

5. The fuel supply system according to claim 1,
wherein the support portions includes first support portions and second support portions;
wherein the shaft members are attached to the first support portions; and
wherein when the shaft members are transferred from the first support portions to the second support portions, the relative position of the attachment member in relation to the sub-tank is shifted in the circumferential direction with respect to an axis of the sub-tank.

6. The fuel supply system according to claim 1,
wherein the support portions includes first support portions and second support portions;
wherein the shaft members are attached to the first support portions; and
wherein when the shaft members are transferred from the first support portions to the second support portions, the relative position of the attachment member in relation to the sub-tank is shifted in the radial direction with respect to an axis of the sub-tank.
